(19) United States
(12) Patent Application Publication
(10) Pub. No.: US 2025/0042058 A1
(43) Pub. Date: Feb. 6, 2025

(54) METHOD OF MAKING MICA ROCK PAPER OR DECORATIVE MICA ROCK PAPER

(71) Applicant: Diane Corso, Bensalem, PA (US)

(72) Inventor: Diane Corso, Bensalem, PA (US)

(21) Appl. No.: 18/365,344

(22) Filed: Aug. 4, 2023

(51) Int. Cl. B28D 1/32

(52) U.S. Cl. CPC B28D 1/322

(57) ABSTRACT

A method of fabricating a sheet of a crystalline material, the method includes splitting the crystalline material along crystallographic structural planes into a plurality of crystalline elements before sorting the plurality of crystalline elements into a first size, a second size and a third size. The method further includes placing the first size crystalline elements along an adhesive surface of a substrate; and then broadcasting the second and third sizes of the plurality of crystalline elements against the adhesive surface between the placed first size.

### BACKGROUND OF THE INVENTION

The present invention relates to methods for producing decorative mica and, more particularly, to a method of making mica rock paper or decorative mica rock paper.

Decorative paneling can enhance the aesthetic of vertical surfaces. Decorative mica is a known aesthetic paneling or wallpaper used for decorative effects in interior decorating, architecture, and other endeavors striving to enhance the appearance of an interior space.

Designing decorative mica paneling or wallpaper to taste or for a desired effect, however, is currently challenging. Specifically, creative control over the colors of the resulting decorative mica paneling and wallpaper is hindered by the current methodology of manufacturing the decorative mica paneling and wallpaper. And as a result of trying to achieve selective control of the final color of the decorative mica paneling and wallpaper, compromises in the manufacturing process are currently introduced—for instance, by adding other materials or withholding resin—which has in turn led to poor quality control problems, debris in the final product and less mica used, which diminishes the overall look and feel of the decorative mica paneling and wallpaper. Moreover, these current solutions tend to fall apart if the fabricator holds back on the resin. It is a truism in the decorative paneling business that poor products without quality control causes job failure and loss in sales.

As can be seen, there is a need for a method of making mica rock paper or decorative mica rock paper.

### SUMMARY OF THE INVENTION

The method embodied in the present invention makes decorative mica paneling and mica rock paper cleaner and stronger, while enabling quality control throughout the manufacturing process.

The present invention does not require the use of the factories machine.

The present invention contemplates, in some embodiments, using sticky clear adhesive rolls of film and unlimited source of colors to manually process to form decorative mica paneling and mica rock paper.

The present invention embodies a method of making mica rock paper using resin through a manufacturing film, wherein the use of resin is different from the prior art in that it is involved in the changing of material, as opposed to the prior art currently limited to one material.

The present invention also embodies a method of making mica rock paper with film technology without epoxy.

In one aspect of the present invention, a method of fabricating a sheet of a crystalline material, the method includes splitting the crystalline material along crystallographic structural planes into a plurality of crystalline elements before sorting the plurality of crystalline elements into a first size, a second size and a third size. The method further includes placing the first size crystalline elements along an adhesive surface of a substrate; and then broadcasting the second and third sizes of the plurality of crystalline elements against the adhesive surface between the placed first size.

In another aspect of the present invention, the method further includes compressing the placed and broadcasted crystalline elements under a compression ranging between 100 to 300 pounds per square inch of pressure, wherein the compression is the result of a pressure roller rolled over a protective sheet covering the placed and broadcasted crystalline elements, wherein the compression flattens the placed and broadcasted crystalline elements so that adjacent crystalline elements overlap each other, wherein the adhesive surface is formed by applying a resin over the substrate at a ratio of approximately five to six ounces of resin per six square feet of substrate, wherein the substrate is vinyl having a thickness between 0.002 and 20.0 millimeters, wherein the crystalline material is mica; and further shaking the substrate so as to displace a portion of the plurality of crystalline elements not adhered to the adhesive surface.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a continuation of the flow chart of FIG. 1.

FIG. 3A is an elevation view of an exemplary embodiment of the present invention, illustrating various jagged shapes of the split raw mica/crystals/gemstone spaced apart along the vinyl/film/paper. Note, the length is indeterminant.

FIG. 3B is an elevation view of FIG. 3A with medium pieces of split raw mica/crystals/gemstone added along the vinyl/film/paper.

FIG. 3C is an elevation view of FIG. 3B with small pieces of split raw mica/crystals/gemstone added along the vinyl/film/paper.

FIG. 4 is a side elevation view of a pressure roller of an exemplary embodiment of the present invention, illustrating the roller going over the top of a protective sheet that covers the film/mica below.

FIG. 5 is an elevation view of an exemplary embodiment of a finished product of the present invention, illustrating the overlapping of adjacent pieces of mica.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

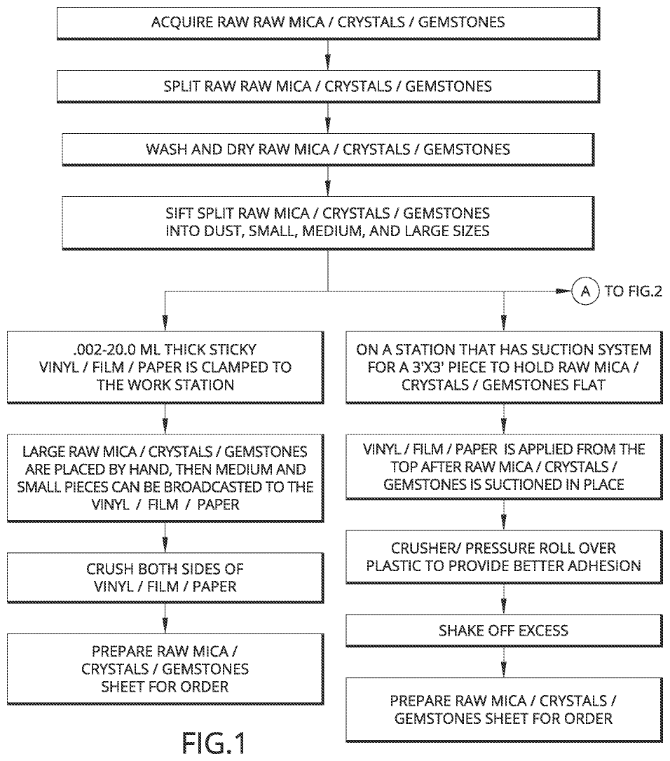

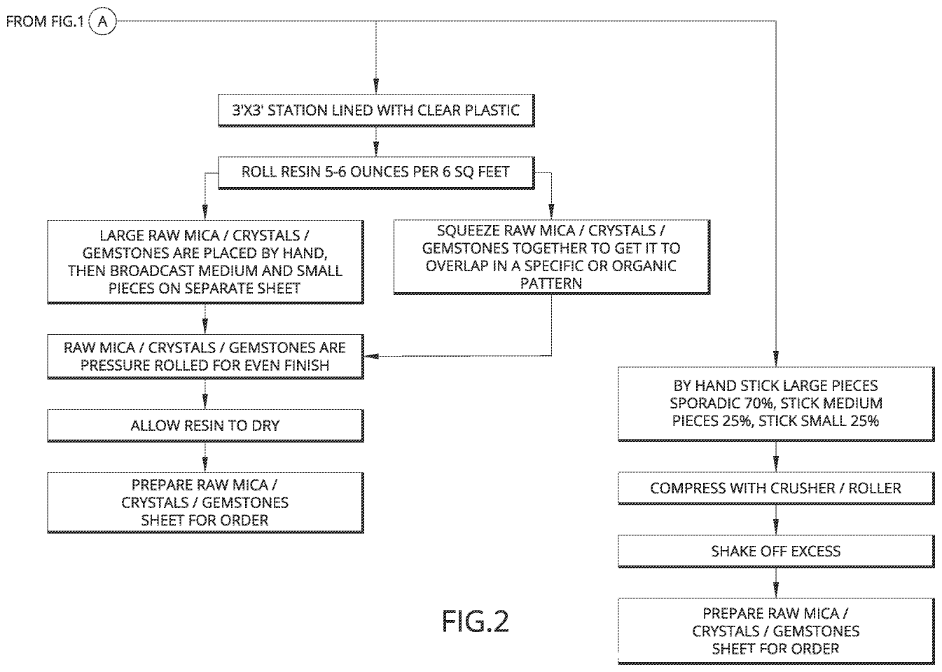

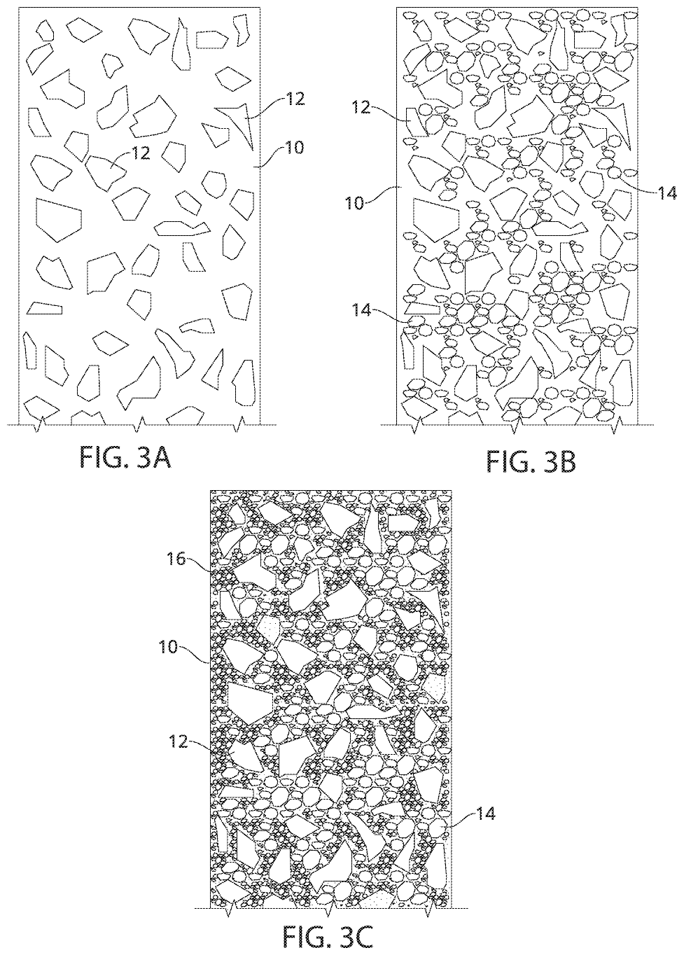

Referring to FIGS. 1 through 5, the present invention provides methods of fabricating decorative rock paper.

First, a fabricator may obtain or acquire raw mica, crystals, gemstones, or other crystalline solids having the requisite physical properties and characteristics associated with a desired aesthetic value. These (mineral) crystalline solids may have crystal lattices or other structural properties that enable cleaving or basal cleaving to split along definite crystallographic structural planes.

Next, the crystalline solids are prepared for the inventive methodology of manufacture/fabrication of decorative rock paper through the following steps: splitting the crystalline solids into constituent elements, and then washing and drying the crystalline element. The splitting may be done by processor blades.

Thereafter, the fabricator sifts the split crystalline element into various categories based on size, which may be defined as dust, small, medium, and large elemental sizes 16, 14, and 12. The large/first elemental size 12 may have a surface area (along one surface/side) of between three and 7 inches. The medium/second elemental size 14 may have a surface area between one and three inches. The small/third elemental size 16 may have a surface area of between 0.25 and one inch.

Then, one of a plurality of fabrication methodologies may be initiated. A first fabrication process may include providing an adhesive substrate 10, for instance a 0.002 through 20.0-millimeter-thick sticky film (vinyl, paper, or the like with resin or epoxy) or other material having an adhesive surface there along. The fabricator may clamp the adhesive substrate to a workstation. Next, the large elements 12 may be manually placed on the adhesive substrate 10. Then the medium-sized and small-sized elements 14 and 16 can be “broadcasted” to the adhesive substrate 10, thereby forming and initial stage of the decorative rock paper. Next, the process includes applying pressure to ensure sufficiently strong adhesion, which may include crushing both sides of the adhesive substrate 10. It is to be understood that the term “broadcast” means distribute the elemental pieces along the surface of the adhesive substrate 10.

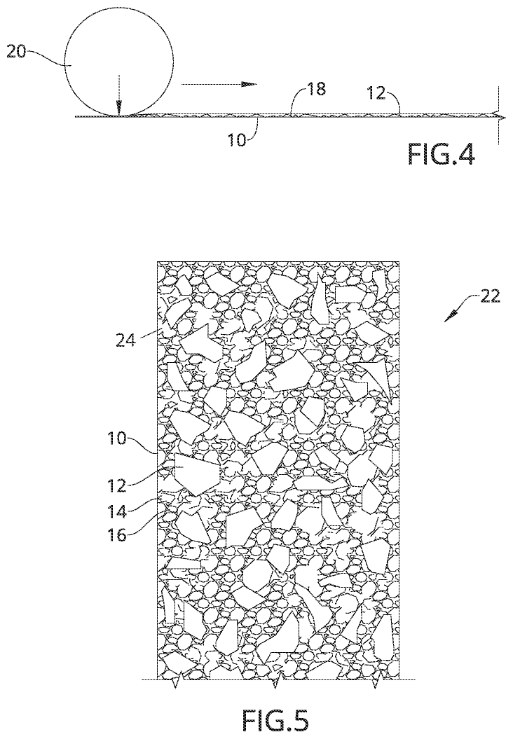

In some embodiments, approximately 100-300 pounds of pressure may be applied to the constituent crystalline elements 12, 14, 16 adhered to the adhesive substrate 10 by way of a pressure roller 20 with a protective sheet 18 covering the crystalline elements, as illustrated in FIG. 4. The application of sufficient pressure results in overlapping regions 24 of adjacent pieces of crystalline elements/mica, as illustrated in FIG. 5. The overlapping regions 24 may include overlapping or stacked portions of adjacent crystalline elements that flattens and expands to form an overlapping arrangement. Finally, the resulting decorative rock paper 20 is cut to size forming a plurality of sheets.

Another of the plurality of fabrication methodologies may include a workstation having a suction system for holding the crystalline solids flat. The fabricator may apply the adhesive substrate 10 to the constituent crystalline elements 12, 14, 16 held in place by the suction system. A crusher or pressure roller may be applied to the back side of the adhesive substrate to provide better adhesion. The process may include shaking off excess crystalline elements 12, 14, 16, by way of a shaker machine integrated with the workstation or manually. The shaking process may include a container for capturing the elements shaken off so that those elements can be repurposed. Finally, the resulting decorative rock paper is cut to size forming a plurality of sheets.

In another embodiment of the inventive process, a workstation may be lined with clear plastic sheet/film, and then resin may be applied thereon at approximately five to six ounces per six square feet of the clear plastic sheet/film. At this point, the fabricator may squeeze raw crystalline solids together so as the cleaved structural planes of constituent crystalline elements overlap to a specific or organic pattern. Alternatively, the large-sized crystalline elements 12 may be placed by hand, then the fabricator may broadcast the medium-size and small-sized crystalline elements on a separate sheet. Then the adhered crystalline elements may be pressure rolled to establish an even finish. The fabricator then allows the resin to dry before the resulting decorative rock paper is cut to size forming a plurality of sheets.

In yet another embodiment of the inventive process, a fabricator may, by hand, sporadically or chaotically adhere large-sized elements 12, medium-sized elements 14, and small-sized elements 12 of the crystalline solid to an adhesive substrate, wherein the ratio of elements is approximately 70:15:15, respectively. Then the fabricator may compress with a crusher or pressure roller 20, and then shake off the excess. Finally, the resulting decorative rock paper is cut to size forming a plurality of sheets.

Once the rock paper is measured by square foot. It gives the installer the ability to adhere an organic mica mineral in very large sections at a time, as opposed to applying crystalline material manually one piece at a time, thereby the present invention enables an incredible fast method to apply decorative mica paneling or wallpaper. Roman Pro 555™ or other wallcovering adhesive can adhere the decorative rock paper to standard vertical surfaces.

The present invention enables creative freedom to change color during an aesthetic process by using different base coats, wherein an installer can also squeegee plasters and paints on top for unique one of kind looks. Having creative control over the decorative rock paper used opens an entire new point of sale for designers and installers to gain revenue. The decorative rock paper 22 can easily be torn into jagged pieces (not shown) to prevent seams from showing while adhering sections to a surface. The installer can place a piece of tape on the back of decorative rock paper 22 and start a jagged tear to use as a hidden seam while adhering to a surface.

The decorative rock paper 22 is more flexible so it delaminates less, which makes for cleaner installation. The decorative rock paper 22 can be installed in larger pieces with less visible seams because it can be ordered to any length for quicker install, saving time and thus money. More colors are available because the fabricator is in control of the elements of crystalline solids being used instead of what the factory processing.

Additionally, decorative rock paper can be used as artistic canvas, decorative window treatment, during sewing, glass covers as well as for use with ceilings and other architectural-component applications.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any 5 unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of fabricating a sheet of a crystalline material, the method comprising:
splitting the crystalline material along crystallographic structural planes into a plurality of crystalline elements;
sorting the plurality of crystalline elements into a first size, a second size and a third size;
placing said first size crystalline elements of the plurality of crystalline elements along an adhesive surface of a substrate; and
broadcasting the second and third sizes of the remaining crystalline elements of the plurality of crystalline elements against the adhesive surface between the placed first size.

2. The method of claim 1, further comprising compressing the placed and broadcasted crystalline elements under a compression ranging between 100 to 300 pounds per square inch of pressure.

3. The method of claim 2, wherein the compression is the result of a pressure roller rolled over a protective sheet covering the placed and broadcasted crystalline elements.

4. The method of claim 2, wherein the compression flattens the placed and broadcasted crystalline elements so that adjacent crystalline elements overlap each other.

5. The method of claim 1, wherein the adhesive surface is formed by applying a resin over the substrate at a ratio of approximately five to six ounces of resin per six square feet of substrate.

6. The method of claim 5, wherein the substrate is vinyl having a thickness between 0.002 and 20.0 millimeters.

7. The method of claim 1, wherein the crystalline material comprises mica.

8. The method of claim 2, further comprising shaking the substrate to displace a portion of the plurality of crystalline elements not adhered to the adhesive surface.
